(19) United States
(12) Patent Application Publication
(10) Pub. No.: US 2007/0028158 A1
(43) Pub. Date: Feb. 1, 2007

(54) Data processing method

(75) Inventors: Dragan Djorovich, Henderson, NV (US); Matthew Jakubiak, Half Moon Bay, CA (US); Suresh Kannan, Foster City, CA (US); Brahmesh Puttannaiah, Bangalore (IN); Natascha Kearsey, Bristol (GB); Chris Evans, Pill (GB); Stephen Cave, Gloucester (GB)

Correspondence Address: BINGHAM MCCUTCHEN LLP, 3000 K STREET, NW, BOX IP, WASHINGTON, DC, 20007, US

(73) Assignee: Oracle International Corporation

(21) Appl. No.: 11/193,346

(22) Filed: Aug. 1, 2005

(51) Int. Cl. G06F 17/21; G06F 17/00; G06F 15/00

(52) U.S. Cl. 715/503; 715/504; 715/509

(57) ABSTRACT

A process definition method is disclosed. The method is typically for use with a report compiled from source data stored in a database and displayed to a user as a table having a plurality of cells. The method comprises: a) presenting the table of cells to the user; b) selecting one of the plurality of cells; and c) defining a drill out function associated with that cell.

### BACKGROUND OF THE INVENTION

1. Field of the Invention

This invention relates to a method for generating a report such as those often created from data stored in a database.

2. Description of the Related Art

It is a common requirement when processing data stored by a database to produce a report. Reports are predefined to extract various relevant items of data from the large amount of data stored in the database and to display these extracted items or other items derived from them in a user friendly format. For example, a database may store profit information for a large company having retail stores in the United States of America. A report may be defined such that, when it is run by a report generator, total profits for each of a plurality of time periods (e.g. months or years) in various regions of the USA are displayed to the user. In this example, the report generator aggregates profit data recorded in the database for each store in a particular region to generate a total profit sum for that region. This is repeated for each region, and it is these aggregated totals that are displayed to the user.

Whilst such a report is useful for showing a top level view of the profits that have been achieved in each particular time period and region, a user may typically want to explore the data that are aggregated to make up the total profit for a specific time period and region. For example, a user may want to determine why the profit achieved in a particular region is particularly high or low compared to those in other regions, and they do this by using the so-called Adrill to detail@ mechanism. When this is invoked, the complete set of data that contributed to the selected cell is shown to the user, and this may help to identify the cause of any particular success or failure, for example due to high performance of low performance of a particular store.

However, implementations of the drill to detail mechanism are normally simple and not very powerful. The actions performed when the drill to detail mechanism is invoked are predefined and cannot be set at runtime. Thus, it is not possible for the end user to define what happens when the drill to detail mechanism is invoked.

### SUMMARY OF THE INVENTION

In accordance with one aspect of the present invention, there is provided a process definition method for use with a report compiled from source data stored in a database and displayed to a user as a table having a plurality of cells, the method comprising:
a) presenting the table of cells to the user;
b) selecting one of the plurality of cells; and
c) defining a drill out function associated with that cell.

The invention overcomes the problems with the prior art by allowing a user to define a drill out function for any of the cells in a table making up a report=s output. The drill out function may define arbitrary processing that is to be performed rather than simply exposing the source data.

Preferably, the method further comprises subsequently displaying a drill out icon indicating that the drill out function has been defined. The drill out icon is normally displayed as a result of running the report, and typically it is displayed on the selected cell.

Typically, the method further comprises storing the drill out function defined in step (c) for future use.

In a preferred embodiment, the step of defining the drill out function includes specifying one or more parameters associated with the cell, each parameter having an associated parameter value on which further processing may be performed. In this case, the step of defining the drill out function normally includes specifying a target data processor to which the parameter value associated with each of the one or more parameters is sent.

The drill out function may specify a uniform resource locator (URL) via which the target data processor is accessed. The target data processor may be accessed via the Internet.

Alternatively, the target data processor may be a report generator for a database. Typically, this will be a default report generator, and the user can select one of a plurality of predefined reports which specifies how the parameter value will be processed.

The step of defining the drill out function may further comprise specifying the correspondence between the one or more parameters associated with the cell and one or more input parameters of the target data processor.

Alternatively, the step of defining the drill out function may include specifying only a target data processor to be activated. In this case, no parameters are specified as part of the drill out function and hence no parameter values are sent to the target data processor.

As before, the drill out function may specify a uniform resource locator (URL) via which the target data processor is activated. The target data processor may be activated via the Internet.

Alternatively, the target data processor may be a report generator for a database, and typically the report generator will be a map generator.

Step (c) may comprise defining a plurality of drill out functions associated with the cell.

Typically, step (a) occurs as a result of running the report.

In accordance with a second aspect of the invention, there is provided a data processing method for use with a report compiled from source data stored in a database and displayed to a user as a table having a plurality of cells, the method comprising:
a) receiving user input indicating one of the plurality of cells;
b) retrieving a drill out function associated with the cell indicated in step (a), the drill out function specifying one or more parameters associated with the cell, and a target data processor to which a parameter value associated with each of the one or more parameters is sent;
c) retrieving, in accordance with the desired drill out function, each parameter value associated with the one or more parameters and sending it to the target data processor.

In accordance with a third aspect of the invention, a data processing method for use with a report compiled from source data stored in a database and displayed to a user as a table having a plurality of cells is provided. The method comprises:
a) receiving user input indicating one of the plurality of cells;
b) displaying a plurality of drill out functions associated with the cell indicated in step (a) to the user, each drill out function specifying one or more parameters associated with the cell, and a target data processor to which a parameter value associated with each of the one or more parameters is sent;
c) receiving user input indicating a desired one of the drill out functions;
d) retrieving the desired drill out function; and
e) retrieving, in accordance with the retrieved drill out function, each parameter value associated with the one or more parameters and sending it to the target data processor.

In accordance with a fourth aspect of the invention, a data processing method for use with a report compiled from source data stored in a database and displayed to a user as a table having a plurality of cells is provided. The method comprises:
a) receiving user input indicating one of the plurality of cells;
b) retrieving a drill out function associated with the cell indicated in step (a), the drill out function specifying a target data processor to be activated;
c) activating the target data processor.

In accordance with a fifth aspect of the invention, a computer program comprises computer program code means adapted to perform the steps of the method according to any of the first, second, third or fourth aspects of the invention when said program is run on the computer.

In accordance with a sixth aspect of the invention, a computer program comprises computer program code means stored on a computer-readable medium for performing the method of any of the first, second, third or fourth aspects of the invention when said program is run on the computer.

### BRIEF DESCRIPTION OF THE DRAWINGS

An embodiment of the invention will now be described with reference to the accompanying drawings, in which:

FIG. 1 shows a flow chart for the process involved in defining a drill out in a first embodiment of the invention;

FIG. 2 shows a flow chart for the process involved when a drill out is invoked in a first embodiment of the invention;

FIG. 3 shows a sample output from a report from which a drill out may be invoked;

FIG. 4 shows the resultant output;

FIG. 5 shows a system on which the invention may be implemented;

FIG. 6 shows a flow chart for the process involved in defining a drill out in a second embodiment of the invention; and

FIG. 7 shows a flow chart for the process involved when a drill out is invoked in a second embodiment of the invention.

### DETAILED DESCRIPTION OF THE PREFERRED EMBODIMENTS

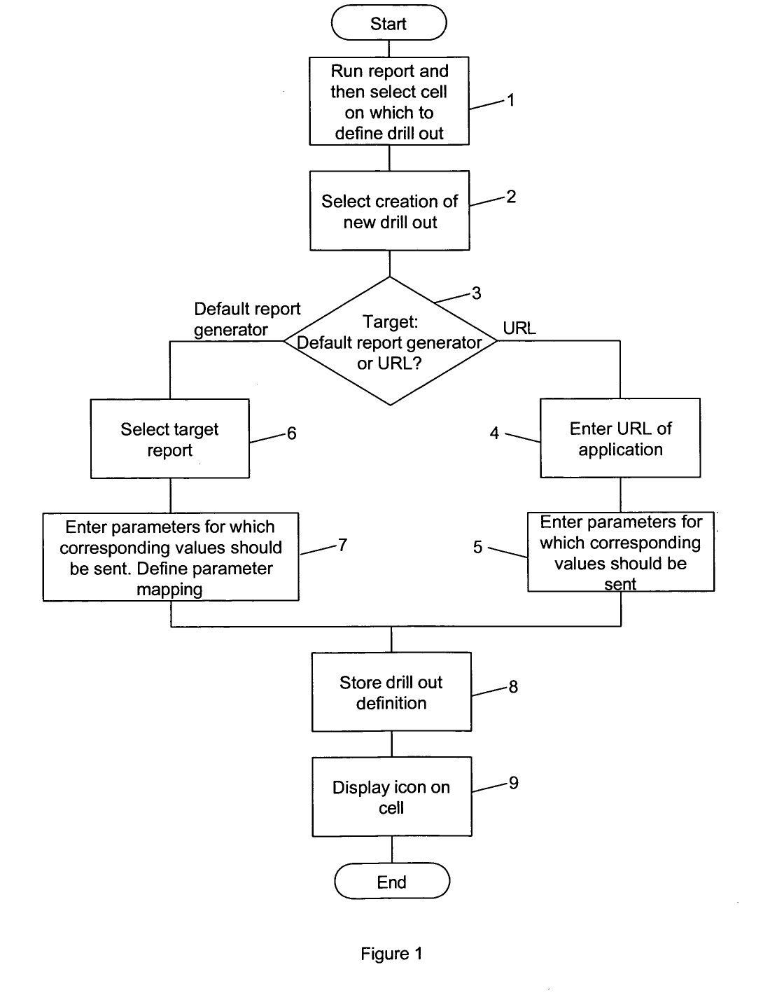

FIG. 1 shows the flow chart for the processing steps which are involved in defining a drill out. The process is started in step 1 when a user runs a report and then selects a cell from the report=s output, for example a table or a crosstab, for which the drill out is to be defined. For example, FIG. 3 shows a crosstab that may be produced as an output of a report. The user may create a drill out for any cell on this crosstab. In step 2, the user indicates to the software that they require to create a new drill out for this cell.

The software responds in step 3 by requesting that the user indicates whether the target of the drill out is a report that can be generated by a default report generator or an application that is accessed by way of a URL.

If the application is accessed by way of a URL, the software proceeds in step 4 by asking the user to input the URL of the target application. The user is also requested in step 5 to indicate one or more parameters associated with the selected cell for which corresponding values should be sent to the target application for processing. The software then generates a composite URL from the URL of the target application and the parameters indicated by the user. For example, the composite URL may be:

http:\\urltarget.com\process?yr=<Year>

This URL makes use of the standard hypertext transfer protocol (HTTP) to pass the value of the parameter AYear@ to a process running on the web server at urltarget.com as the input parameter Ayr@. The process may perform arbitrary processing on the parameter. In this case, the composite URL represents the definition of the drill out.

One possible form of processing that could be performed by the process running on the web server would be to return stock levels for each item indicated in a sales report. In this example, the year parameter may be used as an input to a stock level report such that the report=s output is filtered by the year specified.

In other examples, the web server may use the parameter values to generate a new report, perform processing in a database, send an alert to a user, or send an email based on a target parameter=s values.

In either case, a report is usually run that filters data or checks a condition based on the value of the target parameter and then performs some action based on the result. For example, if a report is run for the year specified in the URL, the result of the report may be that sales targets are not met for the year specified. In this case, the results of the report can then be used to instigate another operation, such as to send an alert or email.

On the other hand, if the user indicates in step 3 that the target of the drill out is a report that can be generated by a default report generator then the software proceeds in step 6 by asking the user to select the target report, and in step 7 to indicate one or more parameters associated with the selected cell for which values are to be sent to the target report. The user may optionally indicate how those parameters map to the target report-s input parameters. In this case, the identity of the target report, the selected parameters and the parameter mapping data represent the definition of the drill out.

In both cases, the software stores the definition of the drill out in step 8 and then, in step 9, displays an icon on the cell for which the drill out has now been defined. The icon indicates that a drill out is defined for that cell, and is also selectable in order to invoke a drill out.

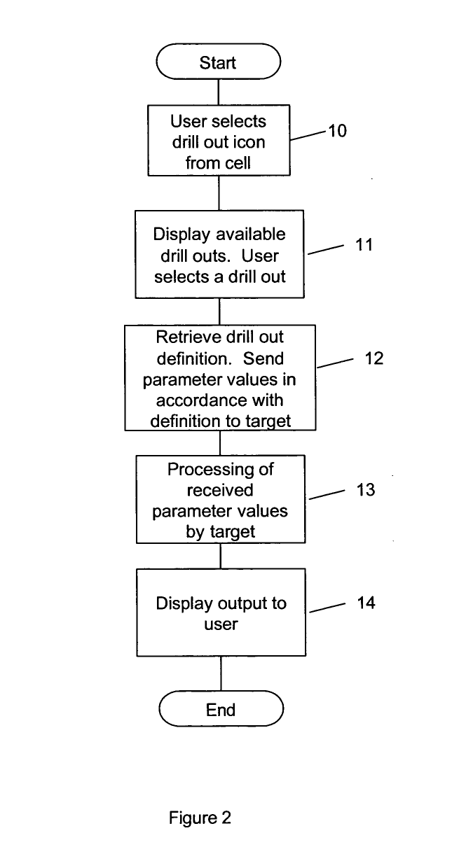

FIG. 2 shows a flow chart of the method that is performed when the user invokes the previously-defined drill out. In step 10, the user selects the drill out icon from the cell. The software proceeds in step 11 by displaying to the user all available drill outs for that cell and requesting that they select one of these. The user selects the desired drill out.

In step 12, the software loads the definition of the drill out and determines for which parameters it is required to send the associated parameter values to the target report generator. At runtime, the parameters defined by the drill out definition are substituted by the associated parameter values from the cell of the source report and these parameter values are then sent to the target data processor.

In step 13, the target data processor processes the received parameter values in accordance with a predetermined and arbitrary method, and then the output of this is displayed in step 14 to the user.

FIG. 3 shows a crosstab that is the output of a source report generator. This example crosstab shows the aggregated profits for an organisation having retail outlets across the USA. The organisation is involved in the sale and rental of video tapes. In particular, the crosstab of FIG. 3 shows the total profit for each of the three years 1998, 1999 and 2000 and for each of three regions: Central, East and West. For example, the cell 20 at the intersection of the 1998 column, and, the Central row indicates that the total profit in 1998 for the Central region was $67,084.

In order to define a drill out for cell 20, the user would follow the procedure already described with reference to FIG. 1. In particular, the user would firstly select the cell 20, and then request the creation of a new drill out, as indicated in steps 1 and 2. In this example, in step 3, the user would indicate that the target data processor is the default report generator, which may be, for example, Oracle7 Discoverer7. The user then selects, in step 6, a target report that can be generated by the default report generator.

The user is then presented, in step 7, with a list of parameters available from the source report and another list of parameters available as inputs to the target report. The user can select from these lists which parameters associated with cell 20 corresponding parameter values are to be sent to the report generator and how the parameters map to the report generator=s input parameters. In this case, it is the AYear@ parameter for which a corresponding value is to be sent to the target report generator, and the user selects this parameter alone from the possible parameters, which are AYear@, ARegion@ and AProfit Sum@ in this case. This completes the definition of the drill out which is then stored for future use as indicated by step 8. Lastly, an icon 21 is displayed on the cell 20 as indicated in step 9.

This icon 21 indicates that a drill out has been defined for cell 20. In response to the user selecting the icon 21 (see step 10 of FIG. 2), the software proceeds to carry out the method shown in the flow chart of FIG. 2. In particular, the software will display all available drill outs for this cell to the user in step 11. The user can then select that which he desires to invoke.

Assuming that he selects the drill out just defined, the software responds in step 12 by retrieving the corresponding definition and then retrieving all the data values for the cell 20, in this case a AYear@ value of A1998″, a ARegion@ value of ACentral@ and a AProfit sum@ value of A$67,084″. In accordance with the drill out definition, the software replaces the AYear@ parameter for which the corresponding value is to be sent to the target data processor with the corresponding data value from cell 20. Thus, in this case the AYear@ parameter is replaced with the corresponding data value A1998″. This data value is mapped to the target report generator=s input parameters in accordance with the drill out definition, and then sent to the target report generator.

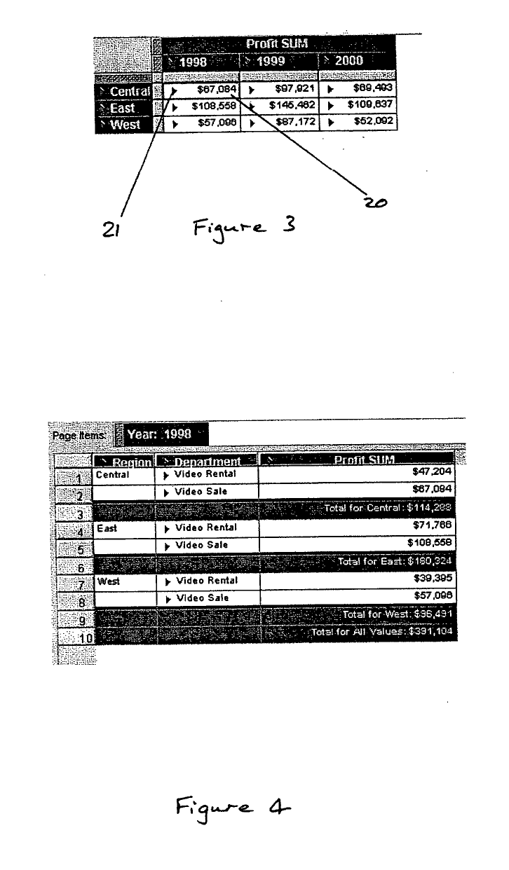

The target report generator then processes the received data in step 13. FIG. 4 shows possible output from the target report generator in which the organisation=s profits due to video sales and video rentals for the year 1998 are shown for each region. Since the 1998 value was passed to the year parameter of the target report, the target report receives the 1998 value and filters its data for 1998. Typically, the target report is set up to query all data, and when it receives a parameter value, it will filter its data by the parameter value. So, if the report has data for 1998, 1999, and 2000, then when it receives the 1998 parameter value, it will only show results for 1998. Any number of parameters can be provided and used in the target report.

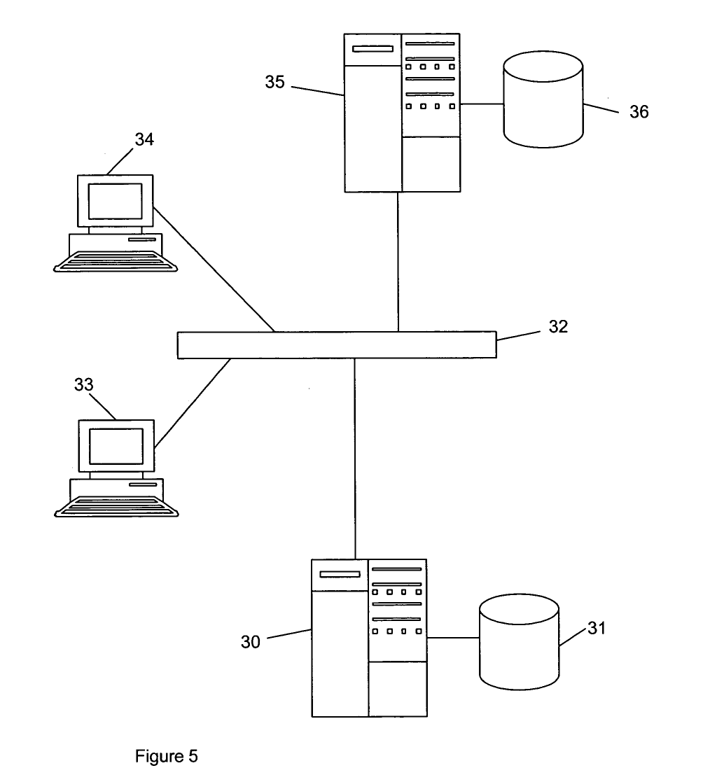

FIG. 5 shows a possible system on which the invention can be implemented. A server 30 is connected to a database 31, and to the Internet 32. The server 30 runs software for accessing the data on the database, report generator software and software for implementing the invention described herein. The database 31 stores data which the server 30 can retrieve for the purposes of generating the reports. It can also store the drill out definitions described above.

Whilst the server 30 can receive user input directly for the purposes of generating reports and defining and invoking drill outs as described above, it is more usual for this input to be conveyed from clients, such as clients 33 and 34, via the Internet 32 to server 30. The server 30 can then process the requests from the clients 33 and 34 and return the processed output data.

FIG. 5 also shows a remote server 35 also connected to the Internet 32 and to its own database 36. The remote server 35 can run a process accessible by way of a URL so that it can act as the target data processor described above. The type of processing performed by the server 35 is arbitrary, but it may as part of this processing retrieve data from database 36. For instance, in the example described above where stock levels for each of the items in a sales report are returned, the server 35 would retrieve the stock levels from database 36 and return the stock levels to server 30, which would then in turn return them to the requesting client 33 or 34 that originally invoked the drill out on the sales report.

In another embodiment of the invention, the definition of the drill out merely involves specifying a target, which as before may be a default report generator or an application that is accessed by way of a URL. No parameters associated with a cell for which the drill out is defined are specified.

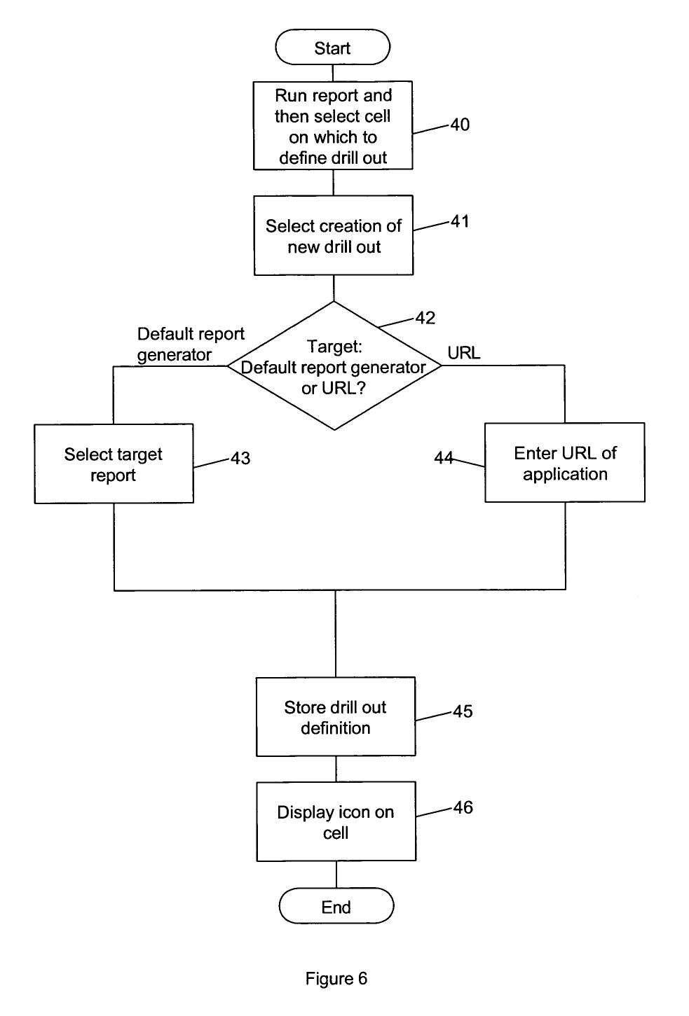

FIG. 6 shows a flow chart of the method involved in defining such a drill out. The process is started in step 40 when a user runs a report and then selects a cell from the report=s output, for example a table or a crosstab, for which the drill out is to be defined. For example, FIG. 3 shows a crosstab that may be produced as an output of a report. The user may create a drill out for any cell on this crosstab. In step 41, the user indicates to the software that they require to create a new drill out for this cell.

The software responds in step 42 by requesting that the user indicates whether the target of the drill out is a report that can be generated by a default report generator or an application that is accessed by way of a URL.

If the application is accessed by way of a URL, the software proceeds in step 44 by asking the user to input the URL of the target application, which user input represents the definition of the drill out.

On the other hand, if the user indicates in step 42 that the target of the drill out is a report that can be generated by a default report generator then the software proceeds in step 43 by asking the user to select the target report. In this case, the identity of the target report represents the definition of the drill out.

In both cases, the software stores the definition of the drill out in step 45 and then, in step 46, displays an icon on the cell for which the drill out has now been defined. The icon indicates that a drill out is defined for that cell, and is also selectable in order to invoke a drill out.

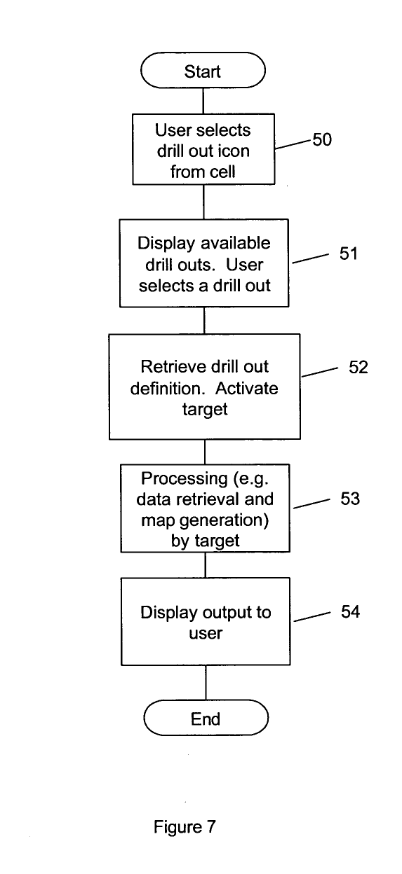

FIG. 7 shows a flow chart of the method that is performed when the user invokes the drill out defined in FIG. 6. In step 50, the user selects the drill out icon from the cell. The software proceeds in step 51 by displaying to the user all available drill outs for that cell and requesting that they select one of these. The user selects the desired drill out.

In step 52, the software loads the definition of the drill out initiates the target, for example by accessing the URL or starting the report generator as appropriate.

In step 53, the target data processor carries out an arbitrary predefined process, and then the output of this process is displayed in step 54 to the user. For example, the target data processor could be a map generator such as Oracle7 Spatial Map Viewer. In this case, invoking the map generator causes a map to be displayed. The map generator may be configured to query data from a database, and thus could display data related to the original report on the map. For example, in the previous scenario where data related to sales and rentals of videotapes were presented in a report, a drill out could be defined simply to invoke the map generator when a particular cell was clicked. The map generator could then (according to its predefined configuration) display a map to the user showing each of the regional offices of the organisation on the map indicating the profits accrued by each office also on the map. These data would be retrieved from the database from which the original report was generated.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media that should be used to carry out the distribution. Examples of computer readable media include recordable-type media such as floppy disk, a hard disk drive, RAM and CD-ROMs as well as transmission-type media, such as digital and analogue communications links.

1. A process definition method for use with a report compiled from source data stored in a database and displayed to a user as a table having a plurality of cells, the method comprising:
a) presenting the table of cells to the user;
b) selecting one of the plurality of cells; and
c) defining a drill out function associated with that cell.

2. A method according to claim 1, wherein the method further comprises subsequently displaying a drill out icon indicating that the drill out function has been defined.

3. A method according to claim 2, wherein the drill out icon is displayed as a result of running the report.

4. A method according to claim 2, wherein the drill out icon is displayed on the selected cell.

5. A method according to claim 1, wherein the method further comprises storing the drill out function defined in step (c) for future use.

6. A method according to claim 1, wherein the step of defining the drill out function includes specifying one or more parameters associated with the cell, each parameter having an associated parameter value on which further processing may be performed.

7. A method according to claim 6, wherein the step of defining the drill out function includes specifying a target data processor to which the parameter value associated with each of the one or more parameters is sent.

8. A method according to claim 7, wherein the drill out function specifies a uniform resource locator (URL) via which the target data processor is accessed.

9. A method according to claim 7, wherein the target data processor is accessed via the Internet.

10. A method according to claim 7, wherein the target data processor is a report generator for a database.

11. A method according to claim 7, wherein the step of defining the drill out function further comprises specifying the correspondence between the one or more parameters associated with the cell and one or more input parameters of the target data processor.

12. A method according to claim 1, wherein the step of defining the drill out function includes specifying a target data processor to be activated.

13. A method according to claim 12, wherein the drill out function specifies a uniform resource locator (URL) via which the target data processor is activated.

14. A method according to claim 12, wherein the target data processor is activated via the Internet.

15. A method according to claim 12, wherein the target data processor is a report generator for a database.

16. A method according to claim 15, wherein the report generator is a map generator.

17. A method according to claim 1, wherein step (c) comprises defining a plurality of drill out functions associated with the cell.

18. A method according to claim 1, wherein step (a) occurs as a result of running the report.

19. A data processing method for use with a report compiled from source data stored in a database and displayed to a user as a table having a plurality of cells, the method comprising:
a) receiving user input indicating one of the plurality of cells;
b) retrieving a drill out function associated with the cell indicated in step (a), the drill out function specifying one or more parameters associated with the cell, and a target data processor to which a parameter value associated with each of the one or more parameters is sent;
c) retrieving, in accordance with the desired drill out function, each parameter value associated with the one or more parameters and sending it to the target data processor.

20. A data processing method for use with a report compiled from source data stored in a database and displayed to a user as a table having a plurality of cells, the method comprising:
a) receiving user input indicating one of the plurality of cells;
b) displaying a plurality of drill out functions associated with the cell indicated in step (a) to the user, each drill out function specifying one or more parameters associated with the cell, and a target data processor to which a parameter value associated with each of the one or more parameters is sent;
c) receiving user input indicating a desired one of the drill out functions;
d) retrieving the desired drill out function; and
e) retrieving, in accordance with the retrieved drill out function, each parameter value associated with the one or more parameters and sending it to the target data processor.

21. A data processing method for use with a report compiled from source data stored in a database and displayed to a user as a table having a plurality of cells, the method comprising:
a) receiving user input indicating one of the plurality of cells;
b) retrieving a drill out function associated with the cell indicated in step (a), the drill out function specifying a target data processor to be activated;
c) activating the target data processor.

22. A computer program comprising computer program code means adapted to perform the steps of claim 1 when said program is run on a computer.

23. A computer program comprising computer program code means stored on a computer-readable medium for performing the method of claim 1 when said program product is run on a computer.

24. A computer program comprising computer program code means adapted to perform the steps of claim 19 when said program is run on a computer.

25. A computer program comprising computer program code means stored on a computer-readable medium for performing the method of claim 19 when said program product is run on a computer.

26. A computer program comprising computer program code means adapted to perform the steps of claim 20 when said program is run on a computer.

27. A computer program comprising computer program code means stored on a computer-readable medium for performing the method of claim 20 when said program product is run on a computer.

28. A computer program comprising computer program code means adapted to perform the steps of claim 21 when said program is run on a computer.

29. A computer program comprising computer program code means stored on a computer-readable medium for performing the method of claim 21 when said program product is run on a computer.
